(19) United States
(12) Patent Application Publication
(10) Pub. No.: US 2001/0013723 A1
(43) Pub. Date: Aug. 16, 2001

(54) Anti-lock brake control device and method

(76) Inventors: Noriyuki Takemasa, Asahi-shi (JP); Keiji Toyoda, Asahi-shi (JP); Hiroshi Oshiro, Asahi-shi (JP)

Correspondence Address: Liniak, Berenato, Longacre & White, Suite 240, 6550 Rock Spring Drive, Bethesda, MD, 20817, US

(21) Appl. No.: 09/725,940

(22) Filed: Nov. 30, 2000

(30) Foreign Application Priority Data
Nov. 30, 1999 (JP) 11-339985

(51) Int. Cl. B60T 8/74

(52) U.S. Cl. 303/177; 303/138

(57) ABSTRACT

An anti-lock brake control method or device which maintains the vehicle stability even if the vehicle drives onto the μ split road surface from a normal road surface. The anti-lock brake control method or device comprises a means to determine the hydraulic pressure in the wheel cylinder of the right and left wheels and a means to change the threshold value which lowers the threshold value for the wheel cylinder of the front wheel with the higher hydraulic pressure to be switched into the pressure reduction mode when the hydraulic pressure difference between the wheel cylinders of the right and left front wheels reaches or exceeds the predetermined hydraulic pressure.

### BACKGROUND OF THE INVENTION

1. Field of the Invention

This invention relates to an anti-lock brake control for a motor vehicle.

2. Description of the Prior Art

Conventionally, there has been a vehicle stability problem while the vehicle with a conventional anti-lock brake control mechanism driving on a split road surface. For example, the vehicle may lose its stability when moving onto the split road surface from a normal road surface.

### SUMMARY AND OBJECT OF THE INVENTION

It is an object of this invention to provide anti-lock brake control which maintains stability of the vehicle while under anti-lock brake control.

It is another object of this invention to provide anti-lock brake control which maintains stability of the vehicle even if the vehicle drives onto the split road surface from the normal road.

With this invention, an anti-lock brake control device for a motor vehicle is provided, which has a hydraulic unit having a main hydraulic circuit connecting a master cylinder and a wheel cylinder via an inlet valve and an auxiliary hydraulic circuit connecting the wheel cylinder and an auxiliary reservoir, a wheel speed sensor determining a wheel speed of the respective wheel, and an electronic control device controlling the hydraulic unit; the device comprising a means to determine the hydraulic pressure in the wheel cylinders of the right and left front wheels, and a means to change a threshold value which lowers the threshold value to switch into a pressure reduction mode relative to the front wheel with higher hydraulic pressure in the wheel cylinder if the hydraulic pressure difference between the right and left front wheels reaches or exceeds the predetermined hydraulic pressure value.

With this invention, an anti-lock brake control device for a motor vehicle is provided, which has a hydraulic unit having a main hydraulic circuit connecting a master cylinder and a wheel cylinder via an inlet valve and an auxiliary hydraulic circuit connecting the wheel cylinder and an auxiliary reservoir, a wheel speed sensor determining a wheel speed of the respective wheel, and an electronic control device controlling the hydraulic unit; the device comprising a means to determine the hydraulic pressure in the wheel cylinders of the right and left front wheels, and a means to reduce the hydraulic pressure in the wheel cylinder with higher hydraulic pressure if the hydraulic pressure difference between the right and left front wheels reaches or exceeds a predetermined hydraulic pressure value and deceleration of the front wheel with lower hydraulic pressure in the wheel cylinder reaches or becomes lower than the predetermined hydraulic pressure value.

With this invention, an anti-lock brake control device for a motor vehicle is provided, which has a hydraulic unit having a main hydraulic circuit connecting a master cylinder and a wheel cylinder via an inlet valve and an auxiliary hydraulic circuit connecting the wheel cylinder and an auxiliary reservoir, a wheel speed sensor determining a wheel speed of the respective wheel, and an electronic control device controlling the hydraulic unit; the device comprising a means to determine the hydraulic pressure in the wheel cylinders of the right and left front wheels, a means to change a threshold value which lowers the threshold value to switch into a pressure reduction mode relative to the front wheel with a higher hydraulic pressure in the wheel cylinder if the hydraulic pressure difference between the right and left front wheels reaches or exceeds the predetermined hydraulic pressure value and a means to hold the pressure increase repeating the pressure hold and pressure increase in turn, each with a predetermined period of time, relative to the front wheel with the higher hydraulic pressure in the wheel cylinder.

With this invention, an anti-lock brake control device for a motor vehicle is provided, which has a hydraulic unit having a main hydraulic circuit connecting a master cylinder and a wheel cylinder via an inlet valve and an auxiliary hydraulic circuit connecting the wheel cylinder and an auxiliary reservoir, a wheel speed sensor determining a wheel speed of the respective wheel, and an electronic control device controlling the hydraulic unit; the device comprising a means to determine the hydraulic pressure in the wheel cylinders of the right and left front wheels, a means to reduce the hydraulic pressure of the wheel cylinder with higher hydraulic pressure if the hydraulic pressure difference between the right and left front wheels reaches or exceeds the predetermined hydraulic pressure value and deceleration of the front wheel with lower hydraulic pressure in the wheel cylinder reaches or becomes lower than the predetermined deceleration, and a means to hold the hydraulic pressure in the wheel cylinder with higher hydraulic pressure, if the hydraulic pressure difference between the right and left front wheels reaches or exceeds the predetermined hydraulic pressure value and deceleration of the front wheel with lower hydraulic pressure in the wheel cylinder reaches or exceeds the predetermined deceleration value but stays within the predetermined deceleration range.

With this invention, an anti-lock brake control method for a motor vehicle having a hydraulic unit having a main hydraulic circuit connecting a master cylinder and a wheel cylinder via an inlet valve and an auxiliary hydraulic circuit connecting the wheel cylinder and an auxiliary reservoir, a wheel speed sensor determining a wheel speed of the respective wheel, and an electronic control device controlling the hydraulic unit is provided. The method comprises a step of determining the hydraulic pressure in the wheel cylinders of right and left front wheels and a step of controlling the hydraulic pressure in the right or left front wheel cylinder with a higher hydraulic pressure under a pressure reduction mode if the hydraulic pressure difference between the right and left front wheels reaches or exceeds the predetermined hydraulic pressure value.

With this invention, an anti-lock brake control method for a motor vehicle having a hydraulic unit having a main hydraulic circuit connecting a master cylinder and a wheel cylinder via an inlet valve and an auxiliary hydraulic circuit connecting the wheel cylinder and an auxiliary reservoir, a wheel speed sensor determining a wheel speed of the respective wheel, and an electronic control device controlling the hydraulic unit is provided. This method comprises a step of determining the hydraulic pressure in the wheel cylinders of right and left front wheels, a step of determining deceleration of front wheel with lower hydraulic pressure in the wheel cylinder, and a step of controlling the hydraulic pressure in the right or left front wheel cylinder with higher hydraulic pressure under a pressure reduction mode if the hydraulic pressure difference between the right and left front wheels reaches or exceeds the predetermined hydraulic pressure value and deceleration of the front wheel with lower hydraulic pressure in that wheel cylinder reaches or becomes lower than the predetermined deceleration.

With this invention, an anti-lock brake control method for a motor vehicle having a hydraulic unit having a main hydraulic circuit connecting a master cylinder and a wheel cylinder via an inlet valve and an auxiliary hydraulic circuit connecting the wheel cylinder and an auxiliary reservoir, a wheel speed sensor determining a wheel speed of the respective wheel, and an electronic control device controlling the hydraulic unit is provided. This method comprises a step of determining the hydraulic pressure in the wheel cylinders of right and left front wheels and a step of controlling the hydraulic pressure in the right or left front wheel cylinder with higher hydraulic pressure under a pressure reduction mode and controlling the hydraulic pressure in the right or left front wheel cylinder with lower hydraulic pressure by repeating the pressure increase more and the pressure hold mode in turn, each with a predetermined period of time if the hydraulic pressure difference between the right and left front wheels reaches or exceeds the predetermined hydraulic pressure value.

With this invention, an anti-lock brake control method for a motor vehicle having a hydraulic unit having a main hydraulic circuit connecting a master cylinder and a wheel cylinder via an inlet valve and an auxiliary hydraulic circuit connecting the wheel cylinder and an auxiliary reservoir, a wheel speed sensor determining a wheel speed of the respective wheel, and an electronic control device controlling the hydraulic unit is provided. This method comprising: a step of determining the hydraulic pressure in the wheel cylinders of right and left front wheels, a step of determining the deceleration of the front wheel with lower hydraulic pressure in the wheel cylinder, and a step of controlling the hydraulic pressure in the right or left front wheel cylinder with higher hydraulic pressure under a pressure reduction mode if the hydraulic pressure difference between the right and left front wheels reaches or exceeds a predetermined hydraulic pressure value and deceleration of the front wheel with lower hydraulic pressure in the wheel cylinder reaches or exceeds a predetermined deceleration value but stays within the predetermined deceleration range.

### BRIEF DESCRIPTION OF THE DRAWINGS

The above and other objects and the attendant advantages of the present invention will become readily apparent by reference to the following detailed description when considered in conjunction with the accompanying drawings wherein:

FIG. 1 is a schematic view of the brake hydraulic pressure control device of this invention:

FIG. 2 is a view explaining the brake hydraulic pressure device for four wheels;

FIG. 3 is a flowchart of the brake hydraulic control; and

FIG. 4 is a flowchart of the brake hydraulic control corresponding to the difference in the road surface.

### DETAILED DESCRIPTION OF THE INVENTION

The preferred embodiment of this invention will now be explained with reference to the appended figures.

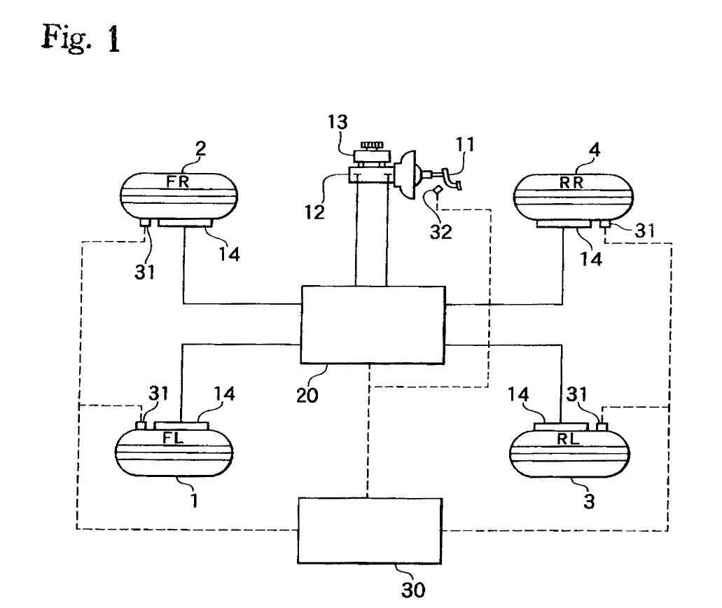

In a brake hydraulic device for a motor vehicle, hydraulic pressure generated in a hydraulic unit 20 is supplied to the respective wheel cylinders 14 for the respective front and rear wheels as shown in FIG. 1 so as to conduct brake control on a left front wheel 1, a right front wheel 2, a left rear wheel 3, and a right rear wheel 4. For example, regarding the brake control such as anti-lock brake control system (ABS), braking force distribution control system, and vehicle behavior control system, an electronic control device 30 controls the hydraulic unit 20 based on signals from a wheel speed sensor 31 and a brake switch 32 in order to provide an appropriate and preferable brake control. Here, the electronic control device 30 may be comprised of a special hardware and general computing members such as microcomputers as would be understood by those of skill in the art.

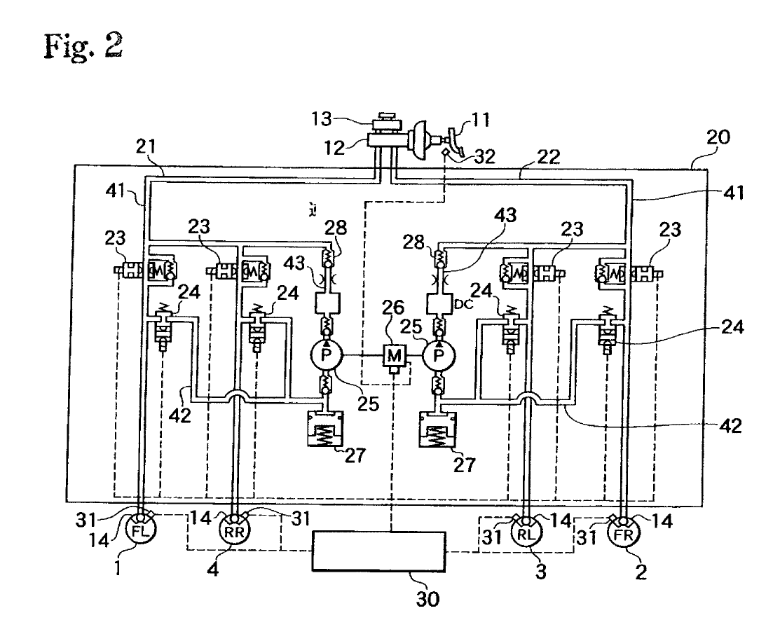

FIG. 2 shows one example of the hydraulic unit 20 which is equipped with a hydraulic circuit for brake control such as the anti-lock brake control system (ABS), the braking force distribution control system, and the vehicle behavior control system. Furthermore, FIG. 2 is an example of an X-piping, wherein the left front wheel 1 and the right rear wheel 4 are connected to a first hydraulic circuit 21 at one side and the right front wheel 2 and the left rear wheel 3 are connected to an independent second hydraulic circuit 22 at the other side.

The hydraulic unit 20 comprises a main hydraulic circuit 41 connecting a master cylinder 12 and a wheel cylinder 14 via an inlet valve 23, an auxiliary hydraulic circuit 42 connecting the wheel cylinder 14, and a return hydraulic circuit 43 returning the hydraulic pressure from the auxiliary reservoir 27 to the main hydraulic circuit 41 via a hydraulic fluid pump 25. The electronic control device 30 controls the opening and closing of the individual inlet valve 23 and outlet valve 24 for conducting the predetermined brake control on the respective wheel. Further, the main reservoir 13 holds the brake fluid, a check valve 28 prevents reverse flow, and a hydraulic pump motor 26 drives and controls the pump 25.

The braking operation of the instant invention will now be explained with reference to the accompanying drawings.

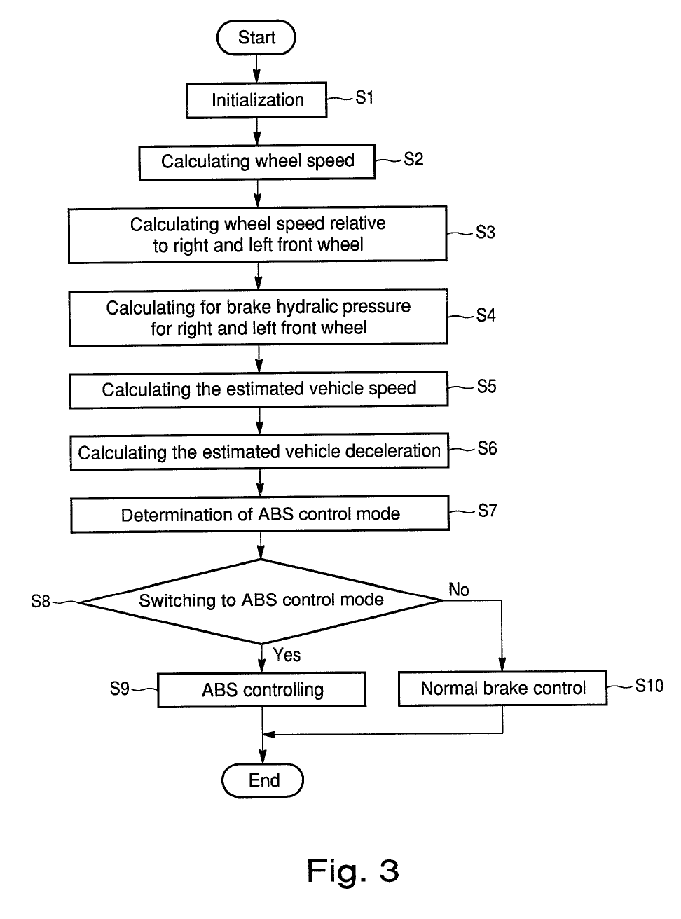

The electronic control device 30 calculates for the brake control for example in FIG. 3 using signals from sensors such as a wheel speed sensor 31. First, in a Step 1 (S1), the electronic control device 30 is initialized and determines the wheel speed based on the signals from the wheel speed sensor 31 in a Step 2 (S2). In a Step 3 (S3), the deceleration of right and left front wheels is determined based on the information regarding the right and left wheel speed. In a Step 4 (S4), brake hydraulic pressure in the wheel cylinder of right and left front wheel is determined based on signals from the hydraulic pressure measurement sensor or the information from the hydraulic control of the hydraulic unit. In Steps 5 and 6 (S5 and S6), an estimated vehicle speed and an estimate vehicle deceleration are determined based on the information from the respective wheel speed. In a Step 7 (S7), a type of brake control mode is determined. If an anti-lock brake control mode is selected in a Step 8 (S8), the anti-lock brake control is conducted in a Step 9 (S9), but if the anti-lock brake control mode is not selected in S8, normal brake control is conducted in a Step 10 (S10).

In normal braking, if a brake pedal 11 is stepped on, brake hydraulic fluid pressure is generated in the master cylinder 12, and the inlet valve 23 is opened while the outlet valve is closed. Then, the brake hydraulic pressure generated in the master cylinder 12 is directly supplied to the wheel cylinder 14, thereby effectuating the brake on the wheels 1, 2, 3, 4.

In the anti-lock brake control, when the braking force acts on the wheels and the wheel slips, the electronic control device 30 determines whether the slip ratio goes beyond the slip threshold value or whether the wheel deceleration goes beyond the deceleration threshold value; opens and closes an inlet valve 23 and an outlet valve 24; and controls a pump 25 to maximize the frictional resistance between the wheels and the road surface. That is, in the anti-lock brake control, the pressure increase mode, the pressure hold mode, and the pressure reduction mode are repeated in turn in every cycle for the purpose of controlling the brake hydraulic pressure. For example, the inlet valve 23 is open-close controlled, and the brake fluid in the wheel cylinder 14 is increased under the pressure increase mode in one cycle.

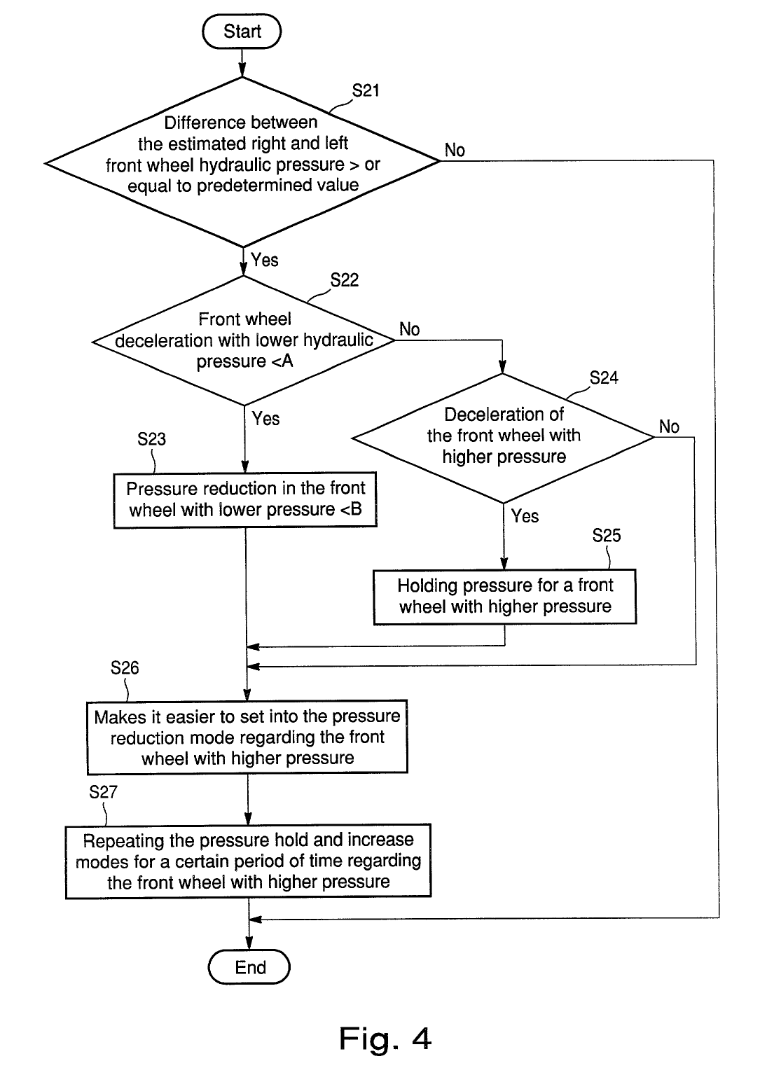

FIG. 4 shows an example of the control while driving on the μ split road surface during the anti-lock brake control. Firstly, hydraulic pressure difference between the estimated wheel speed relative to the right and left front wheels is determined, and whether the hydraulic pressure difference reaches or exceeds the predetermined hydraulic pressure value is determined in a Step 21 (S21). If the difference does not reach or exceed the predetermined hydraulic pressure value, no more determination occurs; however, if the difference reaches or exceeds the predetermined hydraulic pressure value, then whether the front wheel deceleration with lower hydraulic pressure reaches or becomes lower than the predetermined deceleration A is determined in a Step S22 (S22). If the deceleration reaches or becomes lower than A, the hydraulic pressure in the front wheel cylinder with lower hydraulic pressure is reduced in a Step 23 (S23). If the deceleration is not lower than A, whether the front wheel deceleration with lower hydraulic pressure reaches or becomes lower than the predetermined deceleration B is determined in a Step 24 (S24). If the deceleration is lower than B, the hydraulic pressure of the front wheel with higher hydraulic pressure is held in a Step 25. Here, the predetermined deceleration B is larger than the predetermined deceleration A, and additional steps besides the steps to consider the predetermined decelerations A and B may be provided. That is, if the deceleration reaches or exceeds B, whether the front wheel deceleration with lower hydraulic pressure reaches or becomes lower than the next predetermined deceleration value may be determined, and so on.

If the estimated hydraulic pressure difference between the right and left wheels reaches or exceeds the predetermined hydraulic pressure, the front wheel with higher hydraulic pressure is designed to be easily shifted into the pressure reduction mode in a Step 26 (S26). For example, the threshold value for shifting into the pressure reduction mode is lowered. To simplify the process, the Steps 22-25 may be omitted, and if the estimated hydraulic pressure difference between the right and left front wheels reaches or exceeds the predetermined hydraulic pressure, the S26 is immediately conducted.

As necessary, the pressure hold and the pressure increase are repeated in turn relative to the front wheel with higher hydraulic pressure in a Step 27. Then, if the hydraulic pressure difference between the right and front wheels exists, the braking force is secured to gradually increase the hydraulic pressure of the front wheel on a higher μ road surface.

This invention has the following advantages.

This invention provides an anti-lock brake control that maintains vehicle stability during the anti-lock brake control.

This invention provide an anti-lock brake control that maintains vehicle stability even if the vehicle drives from a normal road surface onto the μ split road surface.

It is readily apparent that the above-described has the advantage of wide commercial utility. It should be understood that the specific form of the invention hereinabove described is intended to be representative only, as certain modifications within the scope of these teachings will be apparent to those skilled in the art.

Accordingly, reference should be made to the following claims in determining the full scope of the invention.

What we claim is:

1. An anti-lock brake control device for a motor vehicle which has a hydraulic unit having a main hydraulic circuit connecting a master cylinder and a wheel cylinder via an inlet valve and an auxiliary hydraulic circuit connecting the wheel cylinder and an auxiliary reservoir, a wheel speed sensor determining a wheel speed of a respective wheel, and an electronic control device controlling said hydraulic unit; said device comprising:
a means to determine a hydraulic pressure in the wheel cylinders of right and left front wheels, and
a means to change a threshold value which lowers said threshold value to switch into a pressure reduction mode relative to the front wheel with higher hydraulic pressure in the wheel cylinder if a hydraulic pressure difference between the right and left front wheels reaches or exceeds a predetermined hydraulic pressure value.

2. An anti-lock brake control device for a motor vehicle which has a hydraulic unit having a main hydraulic circuit connecting a master cylinder and a wheel cylinder via an inlet valve and an auxiliary hydraulic circuit connecting said wheel cylinder and an auxiliary reservoir, a wheel speed sensor determining a wheel speed of a respective wheel, and an electronic control device controlling said hydraulic unit; said device comprising:
a means to determine a hydraulic pressure in the wheel cylinders of the right and left front wheels, and
a means to reduce the hydraulic pressure in the wheel cylinder with higher hydraulic pressure if a hydraulic pressure difference between the right and left front wheels reaches or exceeds a predetermined hydraulic pressure value and deceleration of a front wheel with lower hydraulic pressure in the wheel cylinder reaches or becomes lower than said predetermined hydraulic pressure value.

3. An anti-lock brake control device for a motor vehicle which has a hydraulic unit having a main hydraulic circuit connecting a master cylinder and a wheel cylinder via an inlet valve and an auxiliary hydraulic circuit connecting said wheel cylinder and an auxiliary reservoir, a wheel speed sensor determining a wheel speed of a respective wheel, and an electronic control device controlling said hydraulic unit; said device comprising:
a means to determine a hydraulic pressure in the wheel cylinders of right and left front wheels,
a means to change a threshold value which lowers the threshold value to switch into a pressure reduction mode relative to a front wheel with a higher hydraulic pressure in the wheel cylinder if a hydraulic pressure difference between the right and left front wheels reaches or exceeds said predetermined hydraulic pressure value and
a means to hold a pressure increase repeating a pressure hold and pressure increase in turn, each with a predetermined period of time, relative to said front wheel with the higher hydraulic pressure in the wheel cylinder.

4. An anti-lock brake control device for a motor vehicle which has a hydraulic unit having a main hydraulic circuit connecting a master cylinder and a wheel cylinder via an inlet valve and an auxiliary hydraulic circuit connecting said wheel cylinder and an auxiliary reservoir, a wheel speed sensor determining a wheel speed of a respective wheel, and an electronic control device controlling said hydraulic unit; said device comprising:
a means to determine a hydraulic pressure in the wheel cylinders of right and left front wheels,
a means to reduce said hydraulic pressure of the wheel cylinder with higher hydraulic pressure if a hydraulic pressure difference between the right and left front wheels reaches or exceeds a predetermined hydraulic pressure value and deceleration of the front wheel with lower hydraulic pressure in the wheel cylinder reaches or becomes lower than a predetermined deceleration, and
a means to hold said hydraulic pressure in the wheel cylinder with higher hydraulic pressure, if said hydraulic pressure difference between the right and left front wheels reaches or exceeds said predetermined hydraulic pressure value and deceleration of the front wheel with lower hydraulic pressure in the wheel cylinder reaches or exceeds said predetermined deceleration value but stays within the predetermined deceleration range.

5. An anti-lock brake control method for a motor vehicle having a hydraulic unit having a main hydraulic circuit connecting a master cylinder and a wheel cylinder via an inlet valve and an auxiliary hydraulic circuit connecting said wheel cylinder and an auxiliary reservoir, a wheel speed sensor determining a wheel speed of a respective wheel, and an electronic control device controlling said hydraulic unit; said method comprising:
a step of determining a hydraulic pressure in said wheel cylinders of right and left front wheels and
a step of controlling said hydraulic pressure in at least one of a right and left front wheel cylinder with a higher hydraulic pressure under a pressure reduction mode if a hydraulic pressure difference between the right and left front wheels reaches or exceeds a predetermined hydraulic pressure value.

6. An anti-lock brake control method for a motor vehicle having a hydraulic unit having a main hydraulic circuit connecting a master cylinder and a wheel cylinder via an inlet valve and an auxiliary hydraulic circuit connecting said wheel cylinder and an auxiliary reservoir, a wheel speed sensor determining a wheel speed of a respective wheel, and an electronic control device controlling said hydraulic unit; said method comprising:
a step of determining hydraulic pressure in the wheel cylinders of right and left front wheels,
a step of determining deceleration of front wheel with lower hydraulic pressure in the wheel cylinder, and
a step of controlling said hydraulic pressure in at least one of the right and left front wheel cylinder with higher hydraulic pressure under a pressure reduction mode if a hydraulic pressure difference between the right and left front wheels reaches or exceeds a predetermined hydraulic pressure value and deceleration of the front wheel with lower hydraulic pressure in said at least one right and left wheel cylinder reaches or becomes lower than the predetermined deceleration.

7. An anti-lock brake control method for a motor vehicle having a hydraulic unit having a main hydraulic circuit connecting a master cylinder and a wheel cylinder via an inlet valve and an auxiliary hydraulic circuit connecting said wheel cylinder and an auxiliary reservoir, a wheel speed sensor determining a wheel speed of a respective wheel, and an electronic control device controlling said hydraulic unit; said method comprising:
a step of determining a hydraulic pressure in wheel cylinders of right and left front wheels and
a step of controlling said hydraulic pressure in at least one of the right and left front wheel cylinder with higher hydraulic pressure under a pressure reduction mode and controlling said hydraulic pressure in the at least one right and left front wheel cylinder with lower hydraulic pressure by repeating a pressure increase more and a pressure hold mode in turn, each with a predetermined period of time if a hydraulic pressure difference between the right and left front wheels reaches or exceeds a predetermined hydraulic pressure value.

8. An anti-lock brake control method for a motor vehicle having a hydraulic unit having a main hydraulic circuit connecting a master cylinder and a wheel cylinder via an inlet valve and an auxiliary hydraulic circuit connecting said wheel cylinder and an auxiliary reservoir, a wheel speed sensor determining a wheel speed of a respective wheel, and an electronic control device controlling said hydraulic unit; said method comprising:
a step of determining a hydraulic pressure in wheel cylinders of right and left front wheels,
a step of determining a deceleration of the front wheel with lower hydraulic pressure in the wheel cylinder, and
a step of controlling said hydraulic pressure in at least one of the right and left front wheel cylinder with higher hydraulic pressure under a pressure reduction mode if a hydraulic pressure difference between the right and left front wheels reaches or exceeds a predetermined hydraulic pressure value and deceleration of the front wheel with lower hydraulic pressure in the wheel cylinder reaches or exceeds a predetermined deceleration value but stays within a predetermined deceleration range.
